(19) United States
(12) Patent Application Publication
(10) Pub. No.: US 2013/0198284 A1
(43) Pub. Date: Aug. 1, 2013

(54) OFFLINE vCARD

(71) Applicants: SRIRAM KARRI, Hyderabad (IN); Bommireddi Ramamohan Reddy, Hyderabad (IN)

(72) Inventors: SRIRAM KARRI, Hyderabad (IN); Bommireddi Ramamohan Reddy, Hyderabad (IN)

(21) Appl. No.: 13/757,876

(22) Filed: Feb. 4, 2013

(51) Int. Cl. H04L 29/08

(52) U.S. Cl. CPC H04L 67/22
USPC 709/204

(57) ABSTRACT

In accordance with an example embodiment a method and system for updating web-based sources associated with a user based on the monitored non-internet based activities in the offline real world are disclosed. The method and system includes summarizing a plurality of attributes of a user, selecting a subset of attributes from the plurality of attributes, generating an offline-verifiable identity certificate (OVIC) based on the selected subset of attributes, issuing the offline-verifiable identity certificate to the user, monitoring the non-internet based activities of the user, and updating the subset of web-based sources associated with the user. The plurality of attributes is collected from web-based sources. The subset of the attributes is embedded in the issued OVIC and the non-internet based activities are associated with the issued OVIC. The web-based sources are updated based on the monitored non-internet based activities.

### TECHNICAL FIELD

The present technology generally relates to generating offline-verifiable identity certificates for web-based users.

### BACKGROUND

Nowadays, most of the web-based users of electronic devices access social networking websites, community portals, e-commerce portals, e-mail, dating portals, job hunt portals, matrimonial portals, blogging portals, photo sharing portals, micro-blogging portals, video sharing portals, and the like. In addition, the users also avails all kinds of offline businesses services like loyalty card services of retailers.

Most of the users provide information about them and create a profile to access these online and offline services. Commonly, this profile has attributes like user Unique Identifier (ID) or Login Name, and is protected by a user-generated and modified alpha-numerical-special character password. For example, a user on a social networking site may give information about his contact, real name, date of birth, primary email ID, mobile phone number, city and nation of residence, among others. However, any and all activities a person may do, including communications, commerce, interactions and negotiations, making a legal contract, among others, can happen only within the online context.

There are existing mechanisms that allow a user to use the login ID and password of one electronic service and enter using these credentials to transact on another electronic service or website. For example, social networking login ID and password are sufficient to enter the website of a gaming application and play a game, or surf to a newspaper website and read an article.

Some mechanisms may allow the user to seamlessly use the online profile and identity of one service or website, like say a micro-blogging website, to also be displayed on other websites. Some of these mechanisms may also allow a user with a virtual profile on a website to carry forward the profile to mobile applications and gadgets, after synchronizing their identities.

Typically, however, these interactions are only between online entities, limited and have no scope for conducting any activity or interaction offline: ranging from communications, commerce, transactions, bids, sharing of information, registering a presence, testing a product, collecting any object. Thus, these virtual identities remain trapped as virtual identities and have no offline scope for extension.

For example, a user, say “user X” is a member simultaneously of an email ID, a social networking site, a video sharing website and a micro-blogging service. Each of these services has some information about user X and allows advertisers to target him. Further, the email ID knows that user X loves baseball, the social networking sites realizes that he loves to travel, the video sharing sites concludes he has a pet dog and the micro-blogging site understands that he is a committed Republican. Online, companies target user X's love for baseball, travel, dogs and Republican party—including a book shop that gives him special discounts on each of these subjects on the respective website, but when he walks into the store, they cannot integrate, or harness, any of the information.

### SUMMARY OF SOME EMBODIMENTS

This summary is provided to introduce a selection of concepts in a simplified form that are further described below in the detailed description. This summary is not intended to identify key or essential features of the claimed subject matter, nor is it intended to be used as an aid in determining the scope of the claimed subject matter.

In one embodiment, the proposed technology integrates updating the web-based sources associated with a user based on the monitored non-internet based activities in the offline real world.

In an example, a disclosed method includes summarizing a plurality of attributes of a user, selecting a subset of attributes from the plurality of attributes, generating an offline-verifiable identity certificate (OVIC) based on the selected subset of attributes, issuing the offline-verifiable identity certificate to the user, monitoring the non-internet based activities of the user and updating the subset of web-based sources associated with the user. The plurality of attributes is collected from web-based sources. The subset of the attributes is embedded in the issued OVIC and the non-internet based activities are associated with the issued OVIC. The web-based sources are updated based on the monitored non-internet based activities.

In another example, a disclosed method includes summarizing a plurality of attributes of a user, selecting a subset of attributes from the plurality of attributes, generating an offline-verifiable identity certificate (OVIC) based on the selected subset of attributes, issuing the offline-verifiable identity certificate to the user and accessing a plurality of web-based sources based on the issued offline-verifiable identity certificate. The plurality of attributes is collected from a plurality of web-based sources. The subset of the attributes is embedded in the issued offline-verifiable identity certificate and the subset of the plurality of web-based sources is accessed based on the attributes embedded in the OVIC of the user.

In an example, a disclosed system includes a memory to store instructions and a processor responsive to stored instructions to perform summarizing a plurality of attributes of a user, selecting a subset of attributes from the plurality of attributes, generate an offline-verifiable identity certificate (OVIC) based on the selected subset of attributes, and monitoring the non-internet based activities of the user and update a subset of plurality of web-based sources associated with the user. The plurality of attributes is collected from a plurality of web-based sources and the non-internet based activities are associated with the OVIC. The plurality of the web-based sources is updated based on the monitored non-internet based activities.

In an example, a non-transitory, computer-readable storage medium storing computer-executable program instructions is disclosed. The non-transitory system implements summarizing a plurality of attributes of a user, selecting a subset of attributes from the plurality of attributes, generating an offline-verifiable identity certificate (OVIC) based on the selected subset of attributes, issuing the OVIC to the user and accessing a plurality of web-based sources based on the issued offline-verifiable identity certificate. The plurality of attributes is collected from a plurality of web-based sources and the subset of the plurality of web-based sources is accessed based on the attributes embedded in the offline-verifiable identity certificate.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates a system for updating the web-based sources associated with a user based on monitored non-internet based activities in an offline real world, in accordance with an exemplary embodiment;

FIG. 2 shows an exemplary pre-formatted Offline Verifiable Identity Card (OVIC), in accordance with an exemplary embodiment;

FIG. 3 illustrates a flowchart for updating a subset of web-based sources associated with the user, in accordance with an exemplary embodiment;

FIG. 4 illustrates a flowchart for accessing a plurality of web-based sources based on issued OVIC, in accordance with an exemplary embodiment; and

FIG. 5 is a block diagram of an exemplary data flow between the user, the electronic service and its database, an offline verifiable identity device (OVID) and the user's OVIC, in accordance with an exemplary embodiment.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

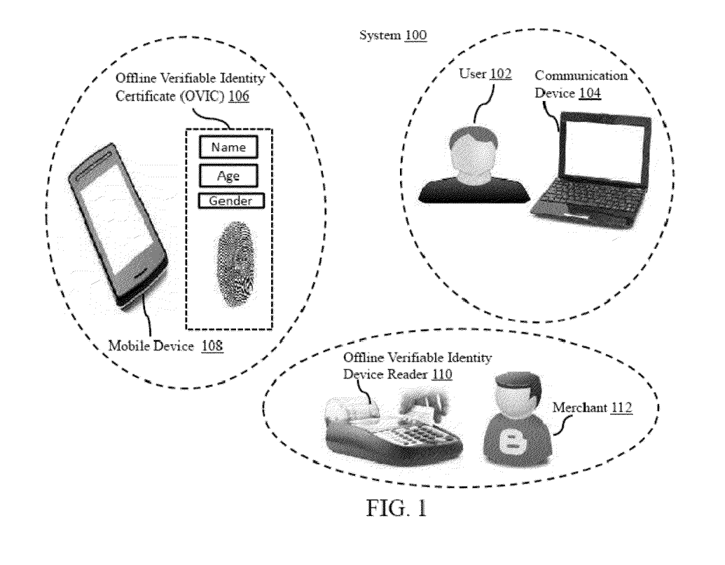

FIG. 1 illustrates a system 100 for updating the web-based sources associated with a user based on the monitored non-internet based activities in the offline real world, in accordance with an exemplary embodiment. The system 100 includes a user 102, a portable communication device 104, an Offline Verifiable Identity Certificate (hereinafter “OVIC”) 106, a mobile device 108, an Offline Verifiable Identity Device (hereinafter “OVID”) 110, and a merchant 112. The user 102 interacts with the portable communication device 104 and access social networking websites, community portals, e-commerce portals, e-mail, dating portals, job hunt portals, matrimonial portals, blogging portals, photo sharing portals, micro-blogging portals, video sharing portals, and the like.

The user 102 creates a profile to access these online and offline services. This profile has attributes like user ID or Login Name, and is protected by a user-generated and modified alpha-numerical password. For example, a user X may give information on a social networking site about his contact, real name, date of birth, primary email ID, mobile phone number, city and nation of residence, and the like.

The system 100 provides the user of a web-based portal (not shown in the figures) and creates an OVIC 106 in the form of a Smart Card Identity, for the user's ‘profile’ of any online community, web portal, social network, email service, e-commerce site, web site, any electronic service, or the electronic offering of any online or offline business (hereinafter termed as “electronic service”). In an embodiment, a web-based portal seeks information from the user 102. The information may include but may not be limited to the attribute information associated with the user 102. In another embodiment, the web-based portal fetches the information from a social networking site. In this embodiment, an application interface associated with the social networking site seeks the permission of the user 102 to fetch the information. The web-based portal creates the OVIC 106 for the user 102.

In an embodiment, the web-based portal summarizes the key identity attributes of the profile of the user 102 and creates the OVIC 106. For example, the web-based portal fetches a plurality of attributes of the user 102 and summarizes the first of attributes. Examples of the plurality of attributes includes, but may not be limited to, name, chosen image, gender, nation, city, postal address, mobile phone number, land line number, E-mail ID, date of birth, and blood group. The web-based portal selects a subset of the plurality of attributes for creating the OVIC 106. In an embodiment, the web-based portal provides the user 102 with an interface to select the first subset of attributes. In an embodiment, the web-based portal summarizes the plurality of attributes, selects a subset of attributes and provides the user 102 to select the subset of attributes to be displayed on the OVIC 106. After selection of the subset of plurality of attributes, the web-based portal confirms the user 102 about the information to be embedded in the OVIC 106 along with a unique multiple characters Alpha-Numerical ID. On confirmation, the OVIC 106 is issued to the user 102.

Those skilled in the art would appreciate that the OVIC 106 can be in any form, including a smart card, a smart phone programmed to be the OVIC 106, a biometric imprint like the thumb or fingerprints, eye retina, and the like. In addition, in context of the present application, the OVIC 106 can be changed based on the particular business or otherwise requirements.

It may be noted that the OVIC 106 can be an identification mechanism. The identification mechanism is used for authentication, securing and measuring of online identity in the real world offline context and can include symbols that can be worn (crowns for kings, medals for soldiers), dress codes (uniforms for army, school, offices), identity card (passports, documents, ID cards), to biometric technology certificates (fingerprint, thumb) to digital-ID certificates (swipe card, proximity card) and the like.

For example, the OVIC 106 of the user 102 can be an ID card with a smart chip, a mobile number programmed to be offline identity, an ID card with thumb or eye retina and the like. This OVIC 106 is used by the user 102 to be identification mechanism of his particular email id.

For example, an OVIC for a user X can be a smart-chip ID card which establishes his email identity offline, a biometric imprint like both thumb impressions to prove his social networking identity in the offline world, a simple paper card to prove his micro-blogging.

In an embodiment, the OVIC 106 may include three layers in which the information is structured. For instance, the first layer may include information printed on the OVIC 106, the second layer may include information available to be read on OVIC 106 in select reading devices (explained later in the patent application), and the third layer may include information available on an electronic service (Online).

In an embodiment, the information printed on the OVIC 106 is the name of the electronic service, and the information may relate to name of the online virtual identity, a unique multiple characters Alpha-Numerical string identifying the physical card, date of issue, expiry date of the card, and the like. This information can be read by the naked human eye. This information may be permanent for each card and can be changed only by re-issuing/replacing the card.

Additionally, there can be information stored inside a passive computer chip of the OVIC 106, where the login credentials and a passkey pertaining to the online or virtual identity on the electronic service the card represents, besides other information such as last location, current location, among others that can be available to be read by the offline verifiable smart card reader. In an embodiment, the choice of how much of information from the existing profile on the electronic service is to be made available on the OVIC 106 depends on the electronic service and the user 102, and is described in sections below. This information is dynamic. In an embodiment, the purpose of the OVIC 106 is to present, in offline mode, to a reader part of the information which is otherwise available online for being read, used, harnessed, edited, changed, worked upon, updated, and the like.

In an embodiment, the OVIC 106 may contain some information which can be accessed online and can be verified by the user 102. This information includes but may not be limited to the virtual identity of the user 102. For example, the user X could be cooldude9@some-email.com, cool.dude@social.networking.com, coolest_dude9@micro-blogging-site.com, and so on. The OVIC 106 can help verify this identity offline, thereby enabling a seamless extension of activities in the real world offline scenario.

In an embodiment, the user 102 designs the OVIC 106 as per the requirement. The user 102 logs into the electronic service (a web-based portal) for creating (applying) the OVIC 106. Continuing the above stated example, the user X logs on a social networking site, links up with his friends and share information of various kinds. In addition, on this social networking site, businesses try to advertise and make their products and wares popular amongst individuals and hope to spread their brand awareness to the social network. On this social networking site, the user X is prompted on a web-based portal, mobile application, and the like to apply for an OVIC 106. The user X is taken to a webpage or a process wherein, there are choices given in some aspects, and some aspects are pre-decided by the electronic service. The user X finalizes an online grid or form to complete the information.

Table 1 provides an exemplary invented solution interacting with an electronic service such as a social networking portal and its database, and the architecture for providing the user X, who can select some attributes and data points to load or to design the OVIC 106. It should be noted that the table 1 is for exemplary purpose and the information provided in the Table 1, can be added, deleted or modified.

TABLE 1

| Information | Electronic service | User | Where stored |
|---|---|---|---|
| CARD SPECIFIC | This information is | The user has no | This data can be |
| Card ID (OVIC ID) | ascertained by the | say on this data. | printed on the card |
| Date of Issue | card or identity | This is valid for | physically |
| Date of Expiry | issuing service, | the lifetime of the | and seen by |
| | | current card or | naked human eye. |
| | | OVIC method. | |
| BASIC | This information is | The user can | This data can be |
| Virtual Identity | taken based on | adjust/change such | printed on the |
| Photograph | existing | information | card physically |
| Real Name | information already | provided by the | and seen by |
| Country | available about the | electronic service | naked human eye. |
| | user on the | before finalization. | |
| | electronic service. | If this needs to be | |
| | This information is | changed, it implies | |
| | mandatory. | a change of card | |
| | | after an elaborate | |
| | | process. | |
| ADVANCED | Does not provide | This information is | This |
| Primary Email ID | this information | given by the User | information is |
| Mobile Number | Electronic Service | based on an opt-in | stored in the |
| Complete Postal | ensures a 2^{nd}- | condition to | smart chip of |
| address | levelauthentication | participate and is | the card, or |
| Date of Birth | mechanism. | voluntary. | equivalent for |
| Gender | | | other variants to |
| Blood Group | | | the certificate. |
| OPTIONAL | Does not provide | This information | This information is |
| Marital Status | this information. | does not need any | stored in the smart |
| Name(s) of top | | authentication. | chip of the card. |
| friends | | User provides info | |
| Interests | | for better ‘know | |
| Last few online | | your customer’. | |
| activities | | | |
| Other such | | | |
| information | | | |
| CONFIDENTIAL | Does not provide | User can use card, | Stored at high |
| Credit card details | this information. | offline certificate | security servers |
| Bank saving account | | to store data but | using highest |
| details | | can't be accessed | security |
| Debit card details | | by anyone else. | processes. |
| Online bank account | | | User can make |
| login details | | | changes, see |
| Other such | | | data online |
| information | | | only. |
| TRANSACTIONAL | The electronic | User is kept aware | A bit of this |
| Previous tracked | service keeps a | of the tracking and | information is |
| locations | track of this | storing of this | stored on the |
| Last tracked location | information. | information. He is | smart chip. All |
| Current tracked | | free to delete some | of it is available |
| location | | or all of this data. | in the user's |
| Previous transactions | | | account of the |
| Last transaction | | | electronic service. |
| Current ongoing | | | |
| transaction | | | |
| Other such | | | |
| information | | | |
| PROFILE/ | Electronic Service | User is free to opt- | Stored online by |
| CONTACT | provides part of this | in, by practicing in | the electronic |
| Can you be called? | information based | Self Declaration, | service. Card is |
| Can you be emailed? | on similar profiling | or participating in | only used to |
| Can you be wished on | practices, analytics, | surveys, etc. | supplement |
| your special days? | done for online | | Electronic |
| What would you like | profile. | | Service to reach |
| as gifts? | | | campaigns, |
| Wish lists! | | | discount info |
| Favorite items in all | | | without giving |
| categories? | | | this info to any |
| Last purchases? | | | third party. |
| Spend propensity. | | | |
| Other such | | | |
| information | | | |
| SOCIAL | Electronic Service | User is free to | Stored online by |
| Family | provides part of this | volunteer, by | the Electronic |
| Best friends | information based | practicing in Self | Service. Card is |
| a) Office buddies | on similar profiling | Declaration, or | only used to |
| b) School/ | practices, analytics, | participating in | supplement |
| College | done for online | surveys, etc. | Electronic |
| Clubs, Fraternities | profile. | | Service to reach |
| Other Groups | | | campaigns, |
| Other Such | | | discount info |
| Information | | | without giving |
| | | | this info to any |
| | | | third party. |

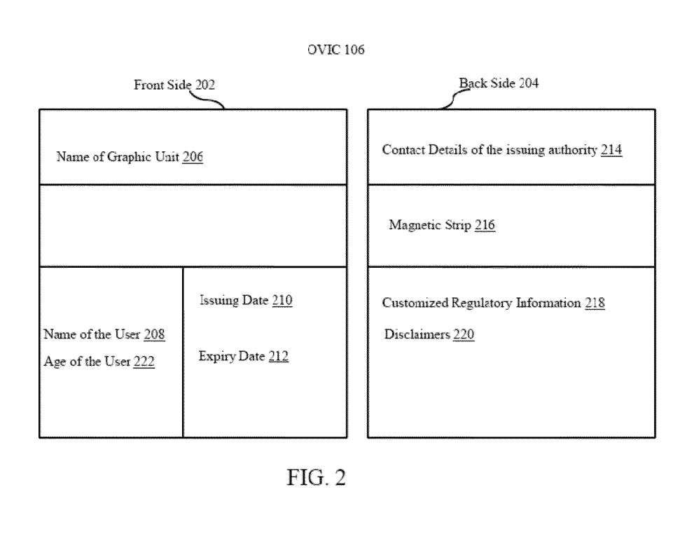

In an embodiment, the user 102 selects a pre-formatted design options in which to arrange the details, look-and-feel of the card and the like. FIG. 2 shows an exemplary pre-formatted OVIC 106. The exemplary pre-formatted OVIC 106 has a front side 202 and a back side 204. The front side 202 and the back side 204 includes, but may not be limited to, name of graphic unit 206, name of the user 208, age of the user 222, issuing date 210, expiry date 212, contact details of the issuing authority 214, magnetic strip 216, customized regulatory information 218, disclaimers 220, and the like. For example, a social networking site can present the user 102 with different format of the OVIC 106. The user 102 selects one of the formats and customizes the OVIC of that social networking site. Some of the information in the pre-formatted OVIC 106 is inserted by the user. In addition, some of the information is already inserted in the OVIC 106 by the system. For example, the issuing date 210 and expiry date 212 is already inserted in the OVIC 106. Those skilled in the art would appreciate that the pre-formatted design of the OVIC 106 shown in the FIG. 2 can have more or less number of attributes of the user and the issuing authority. In addition, the user 102 can also design the OVIC 106 and can insert his own format.

In an embodiment, once the user 102 completes the design of the OVIC 106, an alpha-numerical code (having unique multiple characters) for the OVIC 106 is inserted alongside the other information. The system also hard codes and locks the card's physical authentication system to the user's credentials of the electronic service, wherein, the multiple-digit code refers to the Login ID of the electronic service system. A pass key for the account is saved in the system and so is a corresponding 4-digit-dynamic PIN number which is to be used in conjunction with the card for authentication. The system provides the first or initiating PIN number, and the user 102 can change the PIN code subsequently online.

On completion of the generation of the OVIC 106, the OVIC 106 is dispatched to the user. However, at this stage, the OVIC 106, which has all the data provided by the user 102, is not active. The card is passive. It is activated by a series of steps, which include sending the PIN to the user 102 on his mobile phone (through SMS), thus ensuring the authentication of the phone details. Further, the user 102 is sent the PIN number additionally on the electronic service.

In an embodiment, the user 102 activates the OVIC 106 by typing in the relevant PIN while online, and changing it upfront and creating his or her own generated online PIN code. This authenticates the OVIC 106.

In an embodiment, the user 102 can use the card at merchants, business, or brand outlets globally and swipe the card in a select Offline Verifiable Identity Device 110 (hereinafter “OVID”), type the PIN and authenticate any transaction. The OVID 110 may be present at the establishments of the merchants, business, or brand outlets.

The user 102 may visit a merchant 112 for his daily needs or buying some other necessary or luxury items. The merchant 112 puts in an amount and seeks authentication and approval for the payment for the items bought by the user 102. In an embodiment, a small screen pops up in the OVID 110 which gives a snapshot of the user 102, whose OVIC 106 is swiped. The merchant 112 gets to see the last updated picture, a few interests, upcoming birthdays of friends and family, likes, dislikes of the user 102, thereby allowing the merchant 112 to make personalized offers. All this information provided to the merchant 112 may be seen, read but not stored. Also, the information is given to merchant 112 on getting an approval by the user 102.

Continuing the above stated example, the user X gives his card to a merchant at a book store, and instantly gets to see that he loves dogs and travel. The merchant can throw an impromptu offer wherein, if user X buys $50 worth books on travel, he gets a free coupon for $20 to spend only on books on dogs. Further, the merchant may further on being pointed out by snapshot of user X, remind him of the upcoming birthday of Mary, his sister, and how much she loves books on European paintings, which has a current discount of 30 percent.

In an embodiment of the invention, the moment when the user 102 swipes the OVIC 106 at the OVID 110 to record a transaction, while not being online, the summary of the transaction is transmitted automatically to the relevant profile page of the user in the particular electronic service (web sources). In an embodiment, the summary of the details of the transaction is transmitted to the plurality of web sources or a subset of the plurality of the web sources. In an embodiment, the subset of the web sources may be chosen by the user 102. Continuing the above stated example, the OVIC 106 may correspond to multiple, for example, 5 social networking sites which have collaboration in issuing the OVIC 106. Once the user transacts using the OVIC 106, the summary of the transaction is sent to all the 5 social networking sites. In an embodiment, the summary of the transaction is transmitted to only 3 of the social networking sites for which the user 102 has provided the permission.

Those skilled in the art would appreciate that the above stated example has been explained by using the example of social networking sites, however, the explained scenario is applicable to all the categories of electronic services, such as, websites, micro-blogging, blogging, photo and video sharing, e-mail, e-commerce sites, and the like.

In an embodiment, the transaction summary corresponds to creating a context of information to be collected into objective categories, and processing such data into a human-like message.

Continuing the above stated example, user X may go to a particular coffee shop at 9 am near his office and buys a hot cup of espresso coffee. The OVIC 106 is swiped and he pays the $5 for it. Each of these data fields is sent to the data collection engine connected to the OVIC 106. The data collection engine (not shown in the figure) collates data in following fields: name, city, address, shop name, transaction, price, item, etc. Then, the data collection engine transforms the data into a human message: ‘Name’ ‘Purchased’ ‘Item’ at ‘Shop Name’ ‘Located’ ‘City’ at ‘Time’ for ‘Price’. Hence, the data engine feeds following into the Social Updater: User X purchased a hot cup of espresso coffee at Moontaka Shop in Fountain Plaza, Atlanta, for $5.

The network engine part takes this feed and using the pre-available data on User X's online virtual identity drawn from the OVIC 106, contacts the website whose virtual ID this corresponds with. Hence, if the OVIC 106 is user X's micro-blogging site, the network engine pings the micro-blog website, provides the User ID and password located in the card, and does an auto-login and auto ‘uploads’ this statement as a micro-blog-up. User X, who just went to have a coffee across the street and was offline all along, returns to his office to find his micro-blog updated with his sentence, while he was not connected to the internet.

It may be noted that such updates are not only limited to text, but also have images. For example, the OVID 110 is equipped with a camera, a snap is taken at the time when user X picks his coffee and sends the snap along to the data engine, which processes the image along with the message, and then, through the network engine, uploads the same on the relevant web source.

An exemplary automatic message is composed in the following way: (USER name) just (Purchased/Tried) (name of Company/Brand—Product) at (location, city) and (Got a Discount/Paid Using Store Credits/Got Bonus Points) (number).

User name is taken from the OVIC 106, the company name is stored in the OVID 110 which also hardcode the location, and a list of products is listed.

In another example, if a user Y purchases a cup of hot coffee at Starbucks at Dulles Airport, it would read like this: user Y purchased Café Latte at Starbucks at Dulles Airport, Washington and got 50 Bonus Points. The status message, or micro-blog, or any other such update is made to the web site automatically while the user is actually engaged in a pure offline activity of buying a cup of coffee and collecting some bonus points.

In an embodiment, the system 100 can be used by people to store their money in the form of normal currencies, say US$ or British Pounds, or Euros, and/or also be loaded with store, service or marketplace credits and any form of bonus points. These points are redeemable against their particular value. These (values) loaded on to the OVIC 106 are transferable within the context of the electronic service offering the invention in various ways.

For example, the OVIC 106 can be loaded by paying the electronic service in context with any money, or medium of value exchange and the mode of payment could be all known means: credit card, debit card, online bank transfer, cheque, cash deposit, etc. These are loaded in either direct currency terms like a cash card, or an electronic equivalent.

This OVIC 106 can be used to transfer these values, real or electronic credits, from one user to the other either online, or through a transaction at an OVID 110. For example, the user Y has a friend user Z in the Electronic Service, who has also subscribed to the service offered by the invention.

User X could go online and transfer the currency or credit units online. The transaction is done using a transfer money feature co-located on the electronic service, where user X goes to his page on the electronic service referring to the OVIC 106, and presses button “transfer money”. User Y chooses the name of User Z, from the entire list of friends available to him on his network. A transfer money box pops up, wherein user Y types the number and presses the button Transfer.

For example, if user Y and user Z are connected virtually on some website and both subscribe to the invented product, it is possible for user Y and user Z to transfer their money or virtual points or market credits to each other.

In an the embodiment of the invention, the transfer may be affected at the OVID 110, which is an OVIC 106 reading device located at various merchants, brands and business sales outlets. This would imply that both user Y and user Z would have to visit a merchant location to complete this transfer of value at some point of time.

User Y may swipe his card at any merchant location and pass on any amount of cash or credit units to user Z by pressing a transfer button on the machine. In the said transfer of money or credit units or bonus points, user Y may have two further options of making the transfer.

One option may be to give the unique multiple-digit OVIC code/number of user Z. Else, if user Y had transferred the details of his social contacts to his OVIC card online, names of all friends/contacts would appear on the machine or OVID screen, and user Y may select user Z's name from the list. Post selection of user Z's name from the menu or by directly typing of the multiple-digit number, a prompt asks for the amount, and on typing the amount and pressing the button transfer, the transition may be completed, provided there are sufficient credits.

In an embodiment, it is possible for users to seek currency or credit units or a transfer of bonus points accumulated or available with other users connected to them socially in the network, or connected in any other relevant way in a corresponding electronic service. Users may seek such points in two distinct scenarios and methods.

In an exemplary scenario 1, a user posts an online status message seeking currency or credit units or bonus points from their friends; who then may choose to respond by doing the transfer online. In another case within the same scenario, users can post an SOS alert, which is a special case of asking for quick transfer of currency, credit units or bonus points from their cards to the user sending the SOS, with the critical ruling that SOS alert can be successfully sent only if the current balance of the user falls below a critical pre-defined limit, say $50. This case is a pure online transaction, wherein, in both cases, user Z requests friends for transfer of value: money or marketplace credits or virtual points, on the website directly. In the first case, user Z directly types a message on the status bar seeking transfer of funds, and friends may choose to respond at any time, and transfer any amount. In the second case, user Z presses the SOS button online, where an automatic red-alert is sent to friends to quickly transfer the value: money or virtual points or market credits, but a limit is set. Because of the limit, user Z may not use this feature successfully if she already has the limit in her account. Also, the moment transfers equaling the limit are achieved, the alert may be called off and transfers may not be made.

In an exemplary scenario 2, a user swipes his or her OVIC at a corresponding reader device, or OVID, and a ‘Seek’ button available on the machine is pressed. Once the button is pressed, an online status message seeking currency or credit units or bonus points from their friends is automatically posted; who may then may choose to respond by doing the transfer online, or in case they are offline, by doing a corresponding transfer on any other OVID close to them. This scenario provides for asking for a transfer of funds while being offline, and using the OVID at a merchant's place to send the request. Similarly, friends may also choose to respond to the request either online, or through an OVID.

In another method within the scenario 2, users can post an SOS alert for quick transfer of currency, credit units or bonus points from their cards to the user sending the SOS, with the critical ruling that SOS alert can be successfully sent only if the current balance of the user falls below a critical pre-defined limit, say $50. In this instance, the user swipes the OVIC at an OVID and uses the ‘SOS’ alert, which the system after ascertaining the balance being qualified for such an alert, will post the status message and the friends of the user can make the transfer.

Those skilled in the art would appreciate that the OVIC 106 may have multiple utility values. For example, the OVIC 106 can be an offline verifiable smart ID card, a pre-paid cash card (Debit), a loyalty or Bonus Point card, a Virtual ID card, an Offline Networking card, wherein its interaction with an OVID 110 produces an online status message alert automatically.

In an embodiment, the OVIC 106 can be used as a secure web access card. In this embodiment, the user uses the OVIC 106 to ‘enter’ or ‘logging into’ an electronic service or website without having to use the internet way of data entering the login ID and password. Since the OVIC 106 is hardcoded to the electronic service(s), by swiping the card and entering the PIN code, the user 102 can get access to the particular electronic service.

In an embodiment, the OVIC 106 can be activated or used by ‘proximity’ method in tandem with a pre-verified smart phone 108 or a smart mobile phone 108, or any other smart device; wherein, the OVIC 106 lying dormant in offline mode, when brought close enough to any pre-designated smart device, can read the OVIC 106 and trigger an online linkage for latest updating, and batch closure of all pending activities. During this mode, the OVIC 106 is brought in proximity with the mobile 108 or smart phone 108, or any other smart device 108, ‘smart card offline’ networking component gets connected and downloads the latest information, including the changes done to the profile online, if any, and these are updated to the latest information.

Those skilled in the art would appreciate that it is also within the ambit of the system 100 that the proximity to the phone 108 will activate an application on the phone 108 automatically and the user 102 can then trigger the changes on the instrument ‘powered’ by the proximity to the OVIC 106. These changes could include making online transfers, editing the information relating to the OVIC 106 profile, and the like.

In an embodiment, the OVIC 106 is used purely as a web access card and therefore, the OVIC 106 or any other format of OVIC 106, when ‘swiped’ or inserted into a relevant reader, including a kiosk, smart phone, any OVID 110, or gadget, can allow a user to log into the electronic service without using the conventional manner of data inputting the login ID and password. Thus, this OVIC 106 enables secure web access.

Although the OVIC 106 and OVID 110 have been described as being comprised of various components as listed only, and their functionality, issue, dispatch, and its lifecycle management, including managing of lost-and-found, disabling and de-activating, issue of a new card, or certificate, amongst others have been illustrated, fewer or more components may comprise the solution and still fall within the scope of various embodiments of this technology.

In an embodiment, the OVIC 106 is used as a multiple-web access card, wherein instead of one electronic service, the OVIC 106 is soft-coded to serve as login and password authenticator to several websites or electronic services. In such instances, the user 102 is first given a menu of websites, and on selection of a particular website, the OVIC 106 enables access to the user to that site.

In an exemplary scenario, the user 102 may access multiple websites or electronic services, including an email, a micro blog, a social network and a video sharing service simultaneously, and issue a single OVIC card which corresponds to each of the four virtual identities. In this case, a single OVIC 106 relates to multiple virtual identities and based on context, the relevant virtual identity is invoked.

Continuing the above stated example, user X goes to a coffee shop, an establishment which does business with the social networking site and it gives user X's social networking virtual ID, whereas, later on, when user X goes to buy a pizza, it pops up the micro blog virtual identity because the pizza establishment conducts its business with the micro-blog site.

In all examples above, the OVIC 106 may be demonstrated for sake of explanation as a proximity card, or a swipe card, wherein, users like user X or user Y produced the card physically and swiped it in the OVIC reader. If they just walked past the card reader without swiping it, there would be no transaction or recognition.

In an embodiment, the OVIC 106 has a wireless sensor, such as radio-frequency identification (RFID), or any such mechanism, which can help track the user's location and time spent in any commercial or public establishment, and then be communicated or rewarded as per relevant business rules. In this context, the OVIC 106 automatically allows—with relevant public key infrastructure changes—to locate a person in various places and other information.

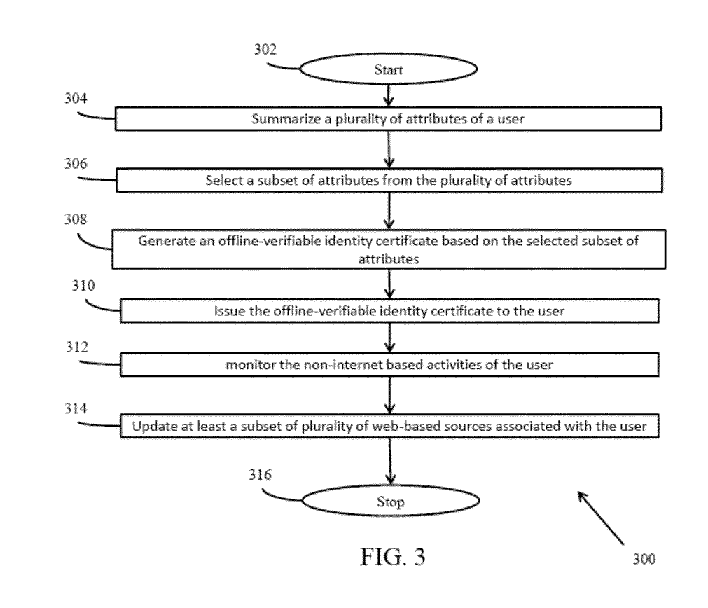

FIG. 3 illustrates a flowchart 300 for updating the subset of web-based sources associated with the user 102, in accordance with an exemplary embodiment. It may be noted that to explain the flowchart 300, direct and indirect references will be made to the system elements of FIG. 1 and FIG. 2.

The flowchart initiates at step 302. At step 304, a plurality of attributes of a user 102 are summarized. The plurality of attributes is collected from a plurality of web-based sources. For example, the attributes related to the profile made by the user 102 on a social networking site is collected and summarized. At step 306, a subset of attributes from the plurality of attributes is selected. A subset of attributes is selected by providing a user interface to the user 102 to select the subset of attributes to be embedded in the OVIC 106 and confirming the subset of attributes to be embedded in the OVIC 106.

At step 308, the OVIC 106 is created based on the selected subset of attributes. At step 310, the OVIC 106 is issued to the user 102. The subset of the attributes is embedded in the issued OVIC 106. At step 312, the non-internet based activities of the user 102 are monitored. The non-internet based activities are associated with the issued OVIC 106. The monitoring of non-internet based activities includes reading the OVIC 106 in a transaction initiated on a transaction terminal of the merchant 112.

At step 314, the subset of plurality of web-based sources associated with the user 102 are updated. The plurality of the web-based sources is updated based on the monitored non-internet based activities. The subset of plurality of web-based sources associated with the user is updated automatically by a computing apparatus on behalf of the user 102 without an input from the user 102. The updates are performed through an application programming interface of the plurality of web-based sources. The updates are performed by verifying the subset of attributes embedded in the OVIC 106. The process of updating includes storing a transaction detail of the OVIC 106 in association with the terminal associated with the merchant 112, generating an automated message containing the transaction detail in a pre-defined template and transmitting the automated message to the subset of the plurality of web-based sources. At step 316, the process terminates.

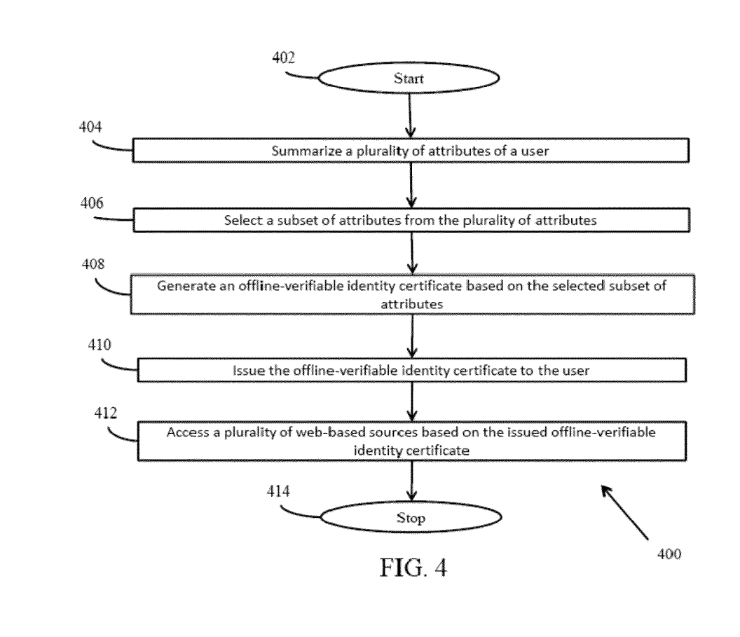

FIG. 4 illustrates a flowchart 400 for accessing a plurality of web-based sources based on the issued OVIC 106, in accordance with an exemplary embodiment. It may be noted that to explain the flowchart 400, direct and indirect references will be made to the system elements of FIGS. 1 and 2.

The process initiates at step 402. At step 404, a plurality of attributes of a user 102 are summarized. The plurality of attributes is collected from a plurality of web-based sources. At step 406, a subset of attributes is selected from the plurality of attributes. At step 408, an OVIC 106 is generated based on the selected subset of attributes. At step 410, the OVIC 106 is issued to the user 102. The subset of the attributes is embedded in the issued OVIC 106. At step 412, a plurality of web-based sources is accessed based on the issued OVIC 106. The subset of the plurality of web-based sources is accessed based on the attributes embedded in the OVIC 106 of the user 102. The plurality of web-based sources is accessed by collecting the subset of plurality of attributes embedded in the OVIC 106 by a terminal during a transaction and verifying the subset of plurality of attributes embedded in the offline-verifiable identity certificate with the subset of plurality of attributes stored for the user 102 in the terminal The process terminates at step 414.

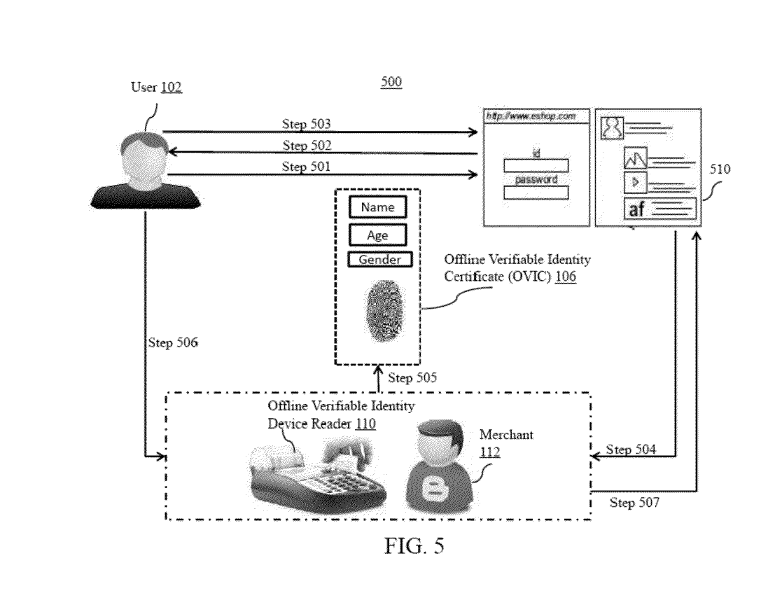

FIG. 5 is a block diagram of an exemplary data flow between the user 102, the electronic service and its database, an offline verifiable identity device (OVID) 110 and the user's OVIC 106, in accordance with an exemplary embodiment. It may be noted that to explain the block diagram 500, direct and indirect references will be made to the system elements of FIGS. 1 and 2.

At step 501, user 102 changes or sends some data on the electronic service. The electronic service can be a social networking site (shown as 510). At step 502, the electronic service displays or sends back the data to the user 102 for verification. At step 503, the user 102 verifies the data and indicates to the electronic service. At step 504, the electronic service conveys the changed or new data to a device which can harness the OVIC 106 which in this case is an OVID 110 installed at a merchant establishment location. The OVID 110 changes the data on the OVIC 106 where it changes in the soft data part. At step 506, the user 102 changes or sends some data to the OVID 110 which can harness the OVIC 106. At step 507, the OVID 110 at the merchant establishment location conveys the new or changed data to the electronic service.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

Common forms of non-transitory computer-readable storage medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer may read.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A method comprising:
i. summarizing a plurality of attributes of a user, the plurality of attributes collected from a plurality of web-based sources;
ii. selecting a subset of attributes from the plurality of attributes;
iii. generating an offline-verifiable identity certificate based on the subset of attributes, wherein the subset of the attributes is embedded in the issued offline-verifiable identity certificate;
iv. issuing the offline-verifiable identity certificate to the user;
v. monitoring non-internet based activities of the user, wherein the non-internet based activities is associated with the issued offline-verifiable identity certificate, and
vi. updating at least a subset of the plurality of web-based sources associated with the user, wherein the subset of the plurality of the web-based sources is updated based on the monitored non-internet based activities.

2. The method of claim 1, wherein the step of selecting a subset of attributes comprises:
i. providing a user interface to the user to select the subset of attributes to be embedded in the offline-verifiable identity certificate; and
ii. confirming the subset of attributes to be embedded in the offline-verifiable identity certificate.

3. The method of claim 1, wherein the step of monitoring the non-internet based activities comprises reading the offline offline-verifiable identity certificate in a transaction initiated on a transaction terminal of a merchant.

4. The method of claim 1, wherein the step of updating the subset of plurality of web-based sources associated with the user is performed automatically by a computing apparatus on behalf of the user without an input from the user.

5. The method of claim 4, wherein the step of updating is performed through an application programming interface of the plurality of web-based sources.

6. The method of claim 1, wherein the step of updating the subset of plurality of web-based sources is performed by verifying the subset of attributes embedded in the offline-verifiable identity certificate.

7. The method of claim 1, wherein the step of updating further comprises:
i. storing a transaction detail of the offline-verifiable identity certificate in association with a terminal associated with a merchant;
ii. generating an automated message containing the transaction detail in a pre-defined template; and
iii. transmitting the automated message to the subset of the plurality of web-based sources.

8. The method of claim 7, wherein the automated message is transmitted with the permission of the user.

9. The method of claim 1, wherein the plurality of the web-based sources is selected by the user.

10. The method of claim 1, wherein the step of monitoring the non-internet based activities comprises a matching of physical presence of the user at a location of the merchant and the attributes associated with the user in the offline offline-verifiable identity certificate.

11. A method comprising:
i. summarizing a plurality of attributes of a user, wherein the plurality of attributes is collected from a plurality of web-based sources;
ii. selecting a subset of attributes from the plurality of attributes;
iii. generating an offline-verifiable identity certificate based on the selected subset of attributes, wherein the subset of the attributes is embedded in the issued offline-verifiable identity certificate;
iv. issuing the offline-verifiable identity certificate to the user; and
v. accessing at least a subset of the plurality of web-based sources based on the issued offline-verifiable identity certificate, wherein the subset of the plurality of web-based sources is accessed based on the subset of attributes embedded in the offline-verifiable identity certificate of the user.

12. The method of claim 11, wherein the step of accessing comprises:
i. collecting the subset of attributes embedded in the offline-verifiable identity certificate by a terminal during a transaction; and
ii. verifying the subset of attributes embedded in the offline-verifiable identity certificate with the subset of attributes stored for the user in the terminal.

13. The method of claim 11, wherein the step of selecting a subset of attributes comprises:
i. providing a user interface to the user to select the subset of attributes to be embedded in the offline-verifiable identity certificate; and
ii. confirming the subset of attributes to be embedded in the offline-verifiable identity certificate.

14. The method of claim 11 further comprising monitoring the non-internet based activities of the user via a transaction initiated by the offline-verifiable identity certificate on a transaction terminal of a merchant.

15. The method of claim 11, wherein the step of selecting is performed by the user through an application programming interface.

16. The method of claim 1, wherein the plurality of the web-based sources is selected by the user.

17. A system comprising:
i. a memory to store instructions; and
ii. a processor responsive to stored instructions to perform
iii. summarize a plurality of attributes of a user, wherein the plurality of attributes is collected from a plurality of web-based sources;
iv. select a subset of attributes from the plurality of attributes;
v. generate an offline-verifiable identity certificate based on the selected subset of attributes;
vi. monitor non-internet based activities of the user, wherein the non-internet based activities is associated with an offline-verifiable identity certificate; and
vii. update at least a subset of the plurality of web-based sources associated with the user, wherein the subset of the plurality of the web-based sources are updated based on the monitored non-internet based activities.

18. The system of claim 17, wherein the processor is further responsive to store instructions to update the subset of plurality of web-based sources by:
i. storing a transaction detail of the offline-verifiable identity certificate in association with a terminal associated with a merchant;
ii. generating a automated message containing the transaction detail in a pre-defined template; and
iii. transmitting the automated message to a subset of the plurality of web-based sources.

19. The system of claim 17, wherein the processor is further responsive to store instructions to update the subset of plurality of web-based sources by an application programming interface of the plurality of web-based sources.

20. A non-transitory, computer-readable storage medium storing computer-executable program instructions to implement:
i. summarizing a plurality of attributes of a user, wherein the plurality of attributes being collected from a plurality of web-based sources;
ii. selecting a subset of attributes from the plurality of attributes;
iii. generating an offline-verifiable identity certificate based on the selected subset of attributes;
iv. issuing the offline-verifiable identity certificate to the user; and
v. accessing at least a subset of the plurality of web-based sources based on the issued offline-verifiable identity certificate, wherein the subset of the plurality of web-based sources is accessed based on the attributes embedded in the offline-verifiable identity certificate.
